(19) United States
(12) Patent Application Publication
(10) Pub. No.: US 2019/0166895 A1
(43) Pub. Date: Jun. 6, 2019

(54) METHOD FOR COOKING FROZEN FISH

(71) Applicants: Michael SIROIS, Portsmouth, NH (US); Douglas B. HALL, Newtown, OH (US)

(72) Inventors: Michael SIROIS, Portsmouth, NH (US); Douglas B. HALL, Newtown, OH (US)

(21) Appl. No.: 16/300,184

(22) PCT Filed: May 9, 2017
(86) PCT No.: PCT/US17/31835

§ 371 Date: Nov. 9, 2018

Related U.S. Application Data
(60) Provisional application No. 62/333,483, filed on May 9, 2016.

(51) Int. Cl. A23L 17/00; A23B 4/06; A23L 5/10; A23L 5/30

(52) U.S. Cl. CPC A23L 17/00; A23B 4/06; A23V 2002/00; A23L 5/30; A23L 5/15

(57) ABSTRACT

This invention is a simplified method of cooking frozen fish that uses multiple scores on the fish to ensure thorough cooking of the fish without overcooking and drying the exterior of the fish.

### CROSS-REFERENCE TO RELATED APPLICATION

The present application claims priority to U.S. provisional patent application No. 62/333,483 as filed May 10, 2016.

### STATEMENT REGARDING FEDERALLY SPONSORED RESEARCH

Not applicable.

### NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND ON THE INVENTION

### 1. Field of the Invention

The present invention relates generally to cooking, particularly cooking seafood.

### 2. Description of the Related Art

It is so difficult and complicated to cook salmon to perfection at home. It's is always dry, overcooked and never tastes the way it does at restaurants.

In addition, cooking salmon from frozen to restaurant grade readiness to eat is perceived to take a long time, but in the present invention, it can be done in as little as 10 minutes or less.

However, the present invention could be used to solve other problems not identified herein; and just a primary problem is identified to give relevance and greater understanding regarding the present invention.

### SUMMARY

The present invention is a Process or method. The process is comprised of the steps of scoring a frozen piece of fish, placing the scored fish into a pan or skillet, and cooking the scored fish.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 is a topside view a piece of fish according to the present invention.

FIG. 2 is a side view of a piece of fish according to the present invention.

FIG. 3 is a topside view of a piece of fish according to the present invention.

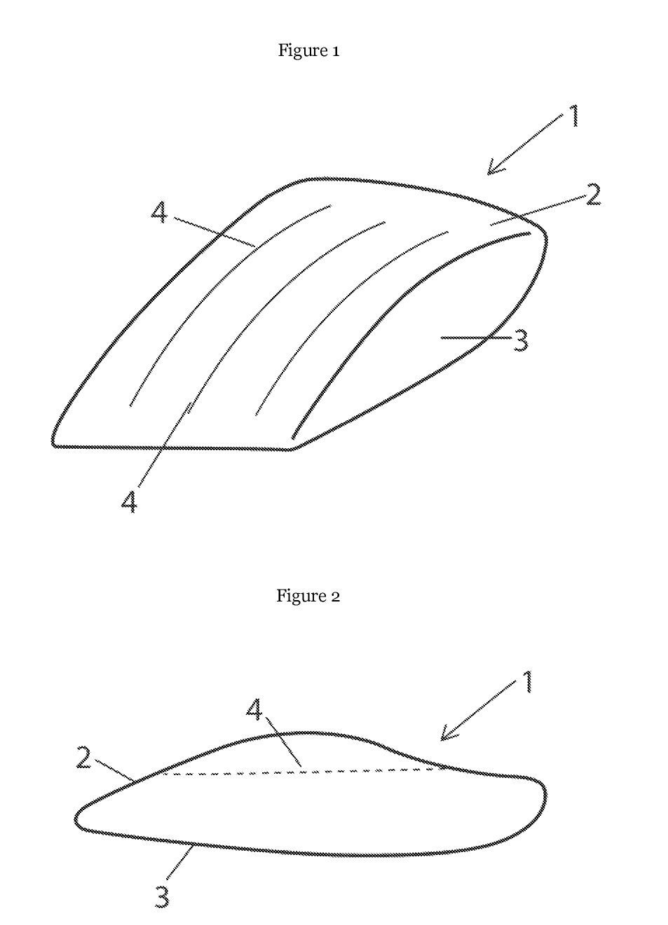

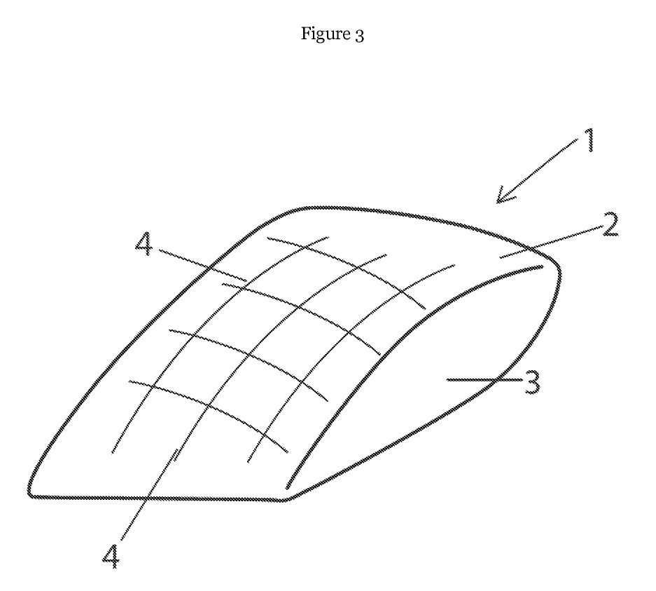

### DESCRIPTION OF THE REFERENCED NUMERALS

In reference to the drawings, similar reference characters denote similar elements throughout all the drawings. The following is a list of the reference characters and associated element:
1 Piece of fish
2 Topside
3 Bottom side
4 Score

### DETAILED DESCRIPTION

The process is comprised of the steps of scoring a frozen piece of fish, placing the scored fish into a pan or skillet, and cooking the scored fish on both sizes. After about 10 minutes, the scored fish is ready and safe for consumption being cooked thoroughly.

The fish fillets or sides throughout this application are preferably at least 22 mm in thickness at the thickest portion of the fish.

The fish can be scored on the topside, bottom side, or both. It is preferred to score both the topside and the bottom side of the fish.

The scoring can be done when the fish is frozen, or it can be done when the fish is thawed and before it is refrozen.

If it is scored while thawed, flavoring, additives, or other ingredients can also be introduced into the scoring before refrozen.

The scoring, on either the topside or bottom side, should each reach no more than about one quarter of the thickness of the fish. Most preferably, the scoring is between about 20% and 25% of the overall thickness of the fish. Thus, the overall scoring will be deeper in the thickest portion of the fish.

The scoring is preferably multiple lines in a single direction and parallel, or the scoring can be a cross-hatch.

When scoring the fish with parallel scores, it is preferred that the scores be between 0.5 cm and 2 cm apart, and most preferably 1 cm apart.

When the scored frozen fish is placed on a pan or skillet for cooking, the scores appear to allow the cooking heat to be introduced into the inside of the piece of fish more efficiently, which allows the fish to cook more thoroughly throughout without drying the exterior of the fish out to an extent that it is not desirable.

Typically cooking a piece of frozen fish as traditionally done on a pan overcooks the exterior of the fish in order to cook the insider thoroughly enough and destroy any possible bacteria. The scoring of the present invention provides for a greater taste and texture in the cooked fish, and without overcooking the fish or having any safety issues.

Traditionally, frozen fish is not cooked on a pan or skillet directly from the freezer as in this invention. Instead, fish is typically thawed, either slowly or by microwave completely before being cooked in a pan or skillet. However, even thawing can lead to the exterior of the fish seemingly thawed with the interior still being very cold or frozen, which then makes the overall cooking more difficult as the fish is not evenly cooking and absorbing the heat.

When cooking the fish in the pan, the fish and pan may be covered with a pan lid or other covering to allow the fish to steam as it cooks. Water, beer, wine, distilled spirit, juice, or a combination thereof can be introduced to the pan as well as the fish cooks in order to add flavor and create a sauce.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention.

What is claimed is:

1. A process for preparing fish for consumption, the process comprising the steps of:
obtaining a fish side or fillet, wherein the fish is at least 22 mm thick at its thickest point;
scoring at least a single side of the fish side or fillet;
freezing the fish side or fillet; and
cooking the fish side or fillet from a frozen state.

2. The process according to claim 1, wherein the scoring includes multiple parallel scores.

3. The process according to claim 2, wherein the scores are between about 0.5 cm and 2 cm apart from one another.

4. The process according to claim 2, wherein the scores are about 1 cm apart from one another.

5. The process according to claim 1, wherein the scoring is multiple cross-hatch or perpendicular scores.

6. The process according to claim 1, wherein the scoring is about 4 cm to about 8 cm depth.

7. The process according to claim 1, wherein the scoring is about 5 cm in depth.

8. The process according to claim 1, wherein the scoring has a depth that is about 18% to 25% of the thickness of the fish side or fillet.

9. The process according to claim 1, wherein the scoring is on opposing sides of the fish.

10. The process according to claim 1, wherein the cooking is conducted in a pan and heated on an oven top.

11. The process according to claim 10, further comprising covering the pan while cooking the fish.

12. The process according to claim 10, further comprising adding a fluid such as water, beer, wine, distilled spirit, juice, or a combination thereof, to the pan.

13. The process according to claim 1, further comprising adding flavorings or additives prior to freezing the fish.
